(19) United States
(12) Patent Application Publication
(10) Pub. No.: US 2007/0256413 A1
(43) Pub. Date: Nov. 8, 2007

(54) Variable geometry EGR mixer and system

(75) Inventors: Damien Marsal, Golbey (FR); Alain R. Lombard, Uxegney (FR); Nathan J. McArdle, Bradford (GB); Alexandre Rouyer, Nancy (FR); Laurent Vautier, Thaon Les Vosges (FR)

Correspondence Address: HONEYWELL TURBO TECHNOLOGIES, 23326 HAWTHORNE BOULEVARD, SUITE #200, TORRANCE, CA, 90505, US

(73) Assignee: Honeywell International, Inc.

(21) Appl. No.: 11/416,296

(22) Filed: May 2, 2006

(51) Int. Cl. F02B 33/44

(52) U.S. Cl. 60/605.2; 60/605.1

(57) ABSTRACT

The present invention provides a long route (i.e., low pressure) EGR system adapted for use in an internal combustion engine, the system providing for a variable mixture of EGR gas and fresh air supply to a turbocharger compressor for delivery to the engine intake manifold and further provides a variable geometry mixer for use in the system.

### CROSS-REFERENCES TO RELATED APPLICATIONS

Not Applicable.

### BACKGROUND OF THE INVENTION

1. Field of the Invention (Technical Field):

The present invention relates to internal combustion engine exhaust gas recirculation (EGR), particularly to a system and method for a long route (i.e., low pressure) EGR system comprising a variable geometry EGR mixer.

2. Description of Related Art:

Note that the where the following discussion refers to a number of publications by author(s) and year of publication, due to recent publication dates certain publications are not to be considered as prior art vis-a-vis the present invention. Discussion of such publications herein is given for more complete background and is not to be construed as an admission that such publications are prior art for patentability determination purposes.

In the reduction of NOx emissions by turbocharged internal combustion engines, long route EGR systems (“LREGR”) (also known as low pressure loop or long path EGR systems) take exhaust gas from a point downstream of the exhaust of the turbocharger exhaust turbine to the turbocharger compressor and on to the intake manifold of the engine. The exhaust gas is typically mixed with fresh air prior to introduction into the intake manifold. LREGR works well at one engine operating point or operation setting such as at low power or load settings. But at high EGR rates that balance of EGR gas to fresh air does not provide optimal emissions control, causes a large fuel penalty, and affects the durability of the compressor wheel.

In a typical LREGR system, it is necessary to create backpressure with an exhaust flap downstream of the turbocharger exhaust turbine to drive EGR gas to the turbocharger compressor. However, this adversely affects the engine's brake-specific fuel consumption (the measure of the engine's efficiency defined as the ratio of the rate of fuel consumption to the rate of power production). Also, during the regeneration phase, there is a need to place a LREGR valve in the system to fully close the LREGR system, and such valves are typically expensive.

Therefore, there is a need to provide a LREGR system that provides optimal fuel and emissions controls over a wide range of power or load settings.

### BRIEF SUMMARY OF THE INVENTION

The present invention provides a long route EGR system comprising a variable geometry mixer for optimizing mixing of exhaust gas and fresh air at all engine operating settings.

Thus, an embodiment of the present invention provides an internal combustion engine system comprising an internal combustion engine comprising an exhaust manifold with an exhaust outlet and an intake manifold with an intake air inlet, a turbocharger comprising an exhaust gas turbine and a compressor, said exhaust gas turbine in fluidic connection with said exhaust outlet to receive exhaust gas, and an EGR mixer in fluidic connection with the exhaust turbine to receive exhaust gas and in fluidic connection with a fresh air inlet to receive fresh air for mixing with the exhaust gas, said EGR mixer comprising a variable geometry for varying the ratio of fresh air to exhaust gas mixed in the EGR mixer, said EGR mixer in fluidic connection with the compressor so that the compressor receives a mixture of the fresh air and the exhaust gas, and said compressor in fluidic connection with the intake air inlet. The EGR mixer preferably comprises an EGR gas inlet of adjustable geometry to vary the amount of EGR gas entering the EGR mixer. The EGR mixer further preferably comprises a valve to adjust the EGR gas inlet. The valve preferably comprises a hollow piston.

Another embodiment of the present invention provides a long route EGR system for use with an internal combustion engine, the engine having an exhaust manifold with an exhaust manifold outlet and an intake manifold with an intake manifold air inlet, said system comprising a low pressure EGR loop in fluidic connection with the exhaust manifold outlet and the intake manifold air inlet, a turbocharger having an exhaust gas turbine and a compressor, an EGR mixer downstream of the exhaust gas turbine, with a first portion of the low pressure EGR loop in fluidic connection with the EGR mixer and with the exhaust gas turbine to receive exhaust gas from the exhaust gas turbine, a fresh air inlet in fluidic connection with the EGR mixer, the EGR mixer comprising a variable geometry for varying a ratio of fresh air and exhaust gas received therein, a second portion of the low pressure EGR loop in fluidic connection with the EGR mixer and with the compressor, and a third portion of the low pressure EGR loop in fluidic connection with the compressor and with the intake manifold air inlet. The EGR mixer preferably comprises an EGR gas inlet of adjustable geometry to vary the amount of EGR gas entering the EGR mixer. The EGR mixer further preferably comprises a valve to adjust the EGR gas inlet. The valve preferably comprises a hollow piston.

Still another embodiment of the present invention provides an EGR mixer for use in a long route EGR system, said mixer comprising a chamber for receiving fresh air and EGR gas, an EGR gas inlet in fluidic communication with the chamber for sending EGR gas into the chamber, and a valve disposed between the chamber and the EGR gas inlet for varying the amount of EGR gas entering the chamber. The mixer further preferably comprises at least one outer wall and at least one inner wall, said inner and said outer walls defining a cavity therebetween, the inner wall defining the chamber, at least one aperture in the inner wall, the EGR gas inlet disposed on the outer wall for receiving EGR gas into the cavity then into the chamber through the at least one aperture, a fresh air inlet at a first end of the mixer for receiving air into the chamber for mixing with EGR gas, and an air outlet at a second end of the mixer for the exit of a mixture of fresh air and EGR gas, and wherein the valve comprises a hollow piston disposed within the chamber, abutting the aperture(s), and axially movable within the chamber to close, partially close, or fully open the aperture(s).

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into, and form a part of, the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a schematic diagram of an embodiment of the present invention showing an engine and EGR system;

FIG. 2 is a perspective view of an embodiment of an EGR mixer of the present invention; and

FIG. 3 is a cross section schematic of the EGR mixer of FIG. 2.

### DETAILED DESCRIPTION OF THE INVENTION

The present invention provides a long route EGR (“LREGR”) system comprising a variable geometry mixer for optimizing the mixing of exhaust gas and fresh air at all engine operation settings.

It is understood that EGR applications may include short route (i.e., high pressure) EGR, LREGR, or a combination of both (i.e., dual EGR systems). The present invention is applicable to the LREGR system regardless of the overall EGR system or system combination utilized.

As used in the specification, including the claims, herein, the terms “a”, “an”, and “the” mean one or more.

Generally, the present invention encompasses a LREGR loop for use in an internal combustion engine. In the loop, an exhaust gas turbine that is in fluidic connection with the engine's exhaust manifold is put in fluidic connection with an EGR mixer so that the EGR mixer receives exhaust gas. The EGR mixer is also in fluidic connection with a fresh air inlet to receive fresh air for mixing with the exhaust gas. The EGR mixer is designed to vary the ratio of fresh air to EGR gas. Thus, an embodiment of the present invention comprises an EGR mixer having a variable geometry, specifically an EGR mixer having an EGR gas inlet of variable geometry. The EGR mixer is also in fluidic connection with the turbocharger compressor so that after the proper mixture of fresh air and EGR gas is achieved, the mixture is sent to the compressor and on to the intake manifold of the engine.

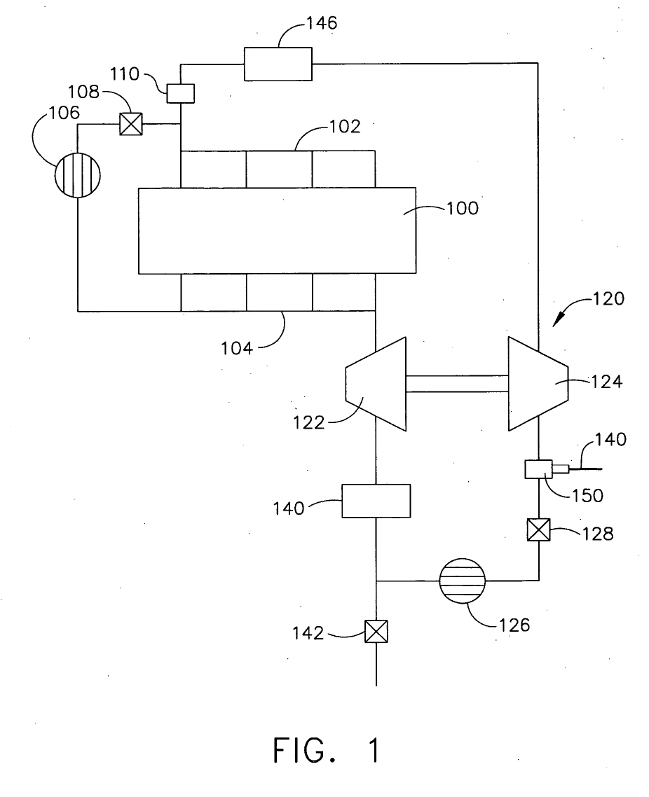

Turning now to the figures, which describe non-limiting embodiments of the present invention that are illustrative of the various embodiments within the scope of the present invention, FIG. 1 is a schematic diagram showing a turbocharged engine and an EGR system employing a LREGR. FIG. 1 serves to illustrate both an application of the prior art EGR and the scope of the present invention, the latter being clear through the discussion that follows with particular attention to the details regarding the exhaust flap, the low pressure EGR valve, and the EGR mixer.

Engine 100 is shown with at least one cylinder in communication with intake manifold 102 and with exhaust manifold 104. Exhaust gas is directed through cooler 106 and on to high pressure EGR valve 108 downstream of cooler 106 and upstream of intake manifold 102. Turbocharger 120 is shown with exhaust turbine 122 downstream of exhaust manifold 104 and upstream of optional emissions controller 140 which may comprise, for example, a diesel particulate filter. Downstream of emissions controller 140 is exhaust flap 142. In the LREGR system, exhaust gas is diverted from exhaust manifold 104 to exhaust turbine 122, through emissions controller 140 and on to cooler 126. Exhaust gas is then sent through low pressure EGR valve 128 to EGR mixer 150 for mixing with fresh air coming into EGR mixer 150 from fresh air intake 140. The mixture of EGR gas and fresh air is sent to turbocharger compressor 124. The fresh air/EGR mixture is sent from compressor 124 through filter 146 and on through control gate 110 to enter intake manifold 102. At a point downstream of control gate 110 and upstream of intake manifold 102, the fresh air/EGR mixture may be mixed with exhaust gas coming through high pressure EGR valve 108.

In a typical LREGR system, there is a need to create backpressure with an exhaust flap, such as exhaust flap 142 shown in FIG. 1, to drive EGR gas to the turbocharger compressor. However, this adversely affects the brake-specific fuel consumption (“BSFC”, a measure of the engine's efficiency defined as the ratio of the rate of fuel consumption to the rate of power production) of the engine. Also, during the regeneration phase, there is a need to place a LREGR valve in the system, such as low pressure EGR valve 128, which is a typically expensive component, to fully close the LREGR system. There is also a need to mix fresh air and EGR gas using a mixer, such as EGR mixer 150, to save the compressor wheel, but the mixture is good only if backpressure is created on the EGR mixer.

The present invention provides for a variable mixture of fresh air and EGR gas and the ability to shut off EGR gas into the LREGR system. An embodiment of the present invention provides for such a variable mixture by providing for a variable geometry EGR mixer. Thus, in FIG. 1, EGR mixer 150 comprises a variable geometry EGR mixer as described in more detail below. The variable geometry may be accomplished via any means known in the art that provides for varying the amount of EGR gas entering the LREGR loop. EGR mixer 150 provides for an optimal compromise between the fresh air/EGR gas mixture and pressure loss on EGR mixer 150 thus benefiting BSFC. Also, because the mixture is good for all engine operation settings, the durability of wheel of compressor 124 is enhanced. Because EGR mixer 150 can be completely closed, the need for low pressure EGR valve 128 is obviated. Therefore, in an embodiment of the present invention making the most use of variable EGR mixer 150, low pressure EGR valve 128 may be absent from the LREGR system.

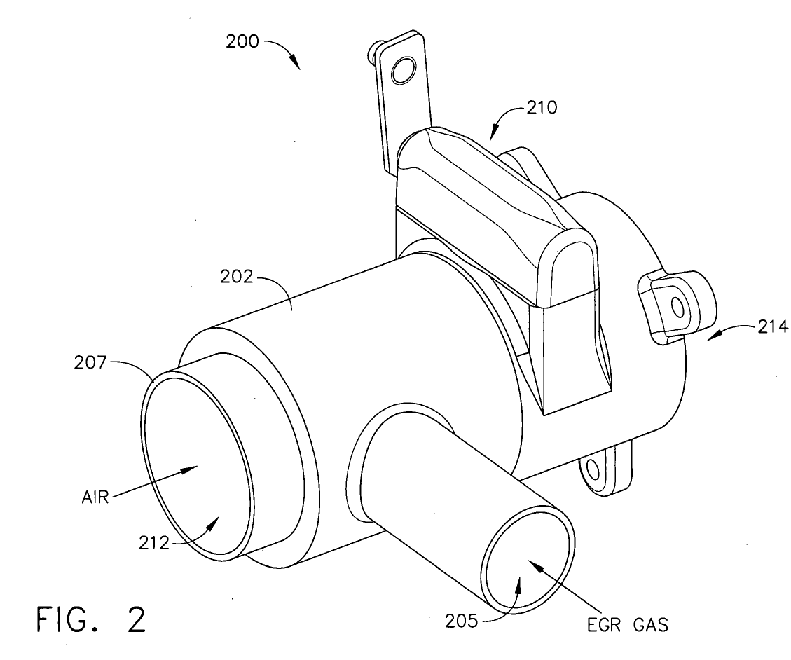

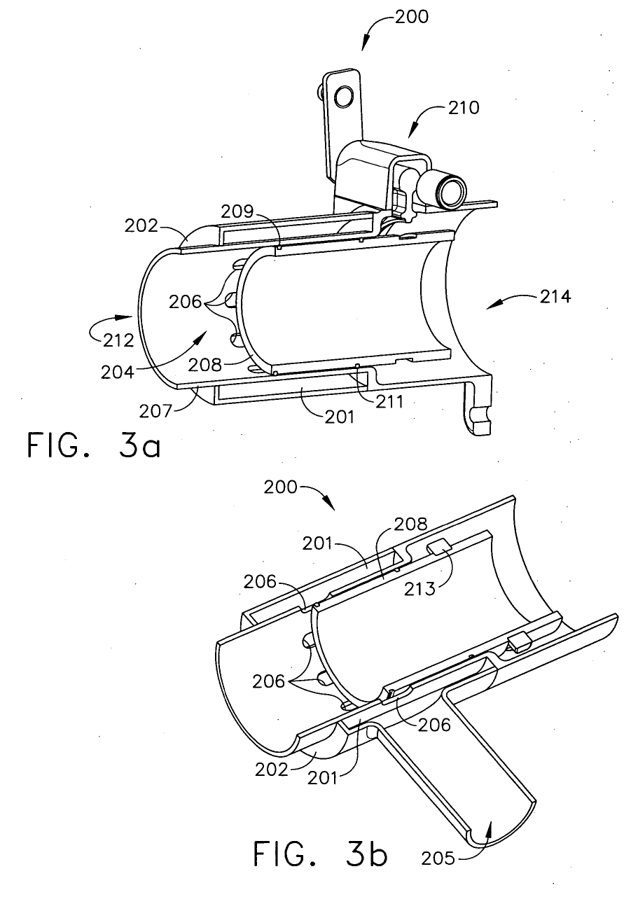

FIGS. 2 and 3 show a representative embodiment of a variable EGR mixer 200 for use in the LREGR system described herein. Mixer 200 comprises housing 202, at least a portion of which is double-walled, cavity 201 within the double walls, and a valve, shown as hollow piston 208, disposed therein. EGR gas flows through mixer opening/inlet 205, then through chamber apertures/inlets 206, into chamber 204. Fresh air flows through opening 212 into chamber 204 where it is mixed with EGR gas, the mixture then flowing out of chamber 204 through opening 214 to enter compressor 124. Piston 208 is axially movable or adjustable within chamber 204 via any means known in the art such as, for example, actuator 210 which is preferably an electric actuator controlled by, for example, an electric coil (not shown) in turn controlled by an engine control unit (not shown), or a pneumatic actuator driven by, for example, EGR gas pressure. Actuator 210 controls the movement of piston 208 by, for example, engaging clip 213. The axial movement of piston 208 provides for apertures 206 to be fully opened, fully closed, or partially opened as a result of the variable position of piston 208 therefore providing for a variable geometry of the mixer and, more specifically, varying or adjusting the geometry/dimensions of chamber apertures/inlets 206. It is understood that in another embodiment, a valve or piston system may be used to vary/adjust the geometry/dimensions of opening/inlet 205. Thus, the amount of EGR gas entering chamber 204 and mixing with fresh air may be controlled. Piston rings 209, 211 provide a seal between piston 208 and inner wall 207 of housing 202.

Because the variable EGR mixer of the present invention may be located as close to the compressor as may be desired, the present invention provides an advantage in realizing a quick increase in engine power when needed. Typically, when an engine is in partial load, it holds a large amount of exhaust gas (for example, a ratio of exhaust gas and fresh air of approximately 1:1). Typically, then, when the need for an increase in engine power arises, the EGR valve will begin to close in conjunction with an increase in fuel injection. However, before a good combustion (and therefore a result in engine power) can be realized, the exhaust gas in the intake line(s) between the EGR valve and the engine must go through, and exit, the engine. After that exhaust gas exits, more fresh air can enter the engine and its combustion chambers(s) thereby resulting in the desired increase in engine power. Therefore, it is advantageous to decrease the distance between the EGR valve and the engine so that the volume of EGR gas in the line(s) prior to entering the engine is reduced. The EGR mixer of the present invention provides this advantage because it can be located close to the compressor so that the LREGR path can be closed off as close to the compressor wheel as possible and thus provide for a quicker introduction of fresh air into the engine's combustion chamber(s).

The preceding examples can be repeated with similar success by substituting the generically or specifically described components, mechanisms, materials, and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An internal combustion engine system comprising:
an internal combustion engine comprising an exhaust manifold with an exhaust outlet and an intake manifold with an intake air inlet;
a turbocharger comprising an exhaust gas turbine and a compressor, said exhaust gas turbine in fluidic connection with said exhaust outlet to receive exhaust gas; and
an EGR mixer in fluidic connection with said exhaust turbine to receive exhaust gas and in fluidic connection with a fresh air inlet to receive fresh air for mixing with the exhaust gas, said EGR mixer comprising a variable geometry for varying the ratio of fresh air to exhaust gas mixed in said EGR mixer;
said EGR mixer in fluidic connection with said compressor so that said compressor receives a mixture of the fresh air and the exhaust gas; and
said compressor in fluidic connection with said intake air inlet.

2. The system of claim 1 wherein said EGR mixer comprises an EGR gas inlet of adjustable geometry to vary the amount of EGR gas entering said EGR mixer.

3. The system of claim 2 further comprising a valve to adjust said EGR gas inlet.

4. The system of claim 3 wherein said valve comprises a hollow piston.

5. A long route EGR system for use with an internal combustion engine, the engine having an exhaust manifold with an exhaust manifold outlet and an intake manifold with an intake manifold air inlet, said system comprising:
a low pressure EGR loop in fluidic connection with the exhaust manifold outlet and the intake manifold air inlet;
a turbocharger having an exhaust gas turbine and a compressor;
an EGR mixer downstream of said exhaust gas turbine, with a first portion of said low pressure EGR loop in fluidic connection with said EGR mixer and with said exhaust gas turbine to receive exhaust gas from said exhaust gas turbine;
a fresh air inlet in fluidic connection with said EGR mixer, said EGR mixer comprising a variable geometry for varying a ratio of fresh air and exhaust gas received therein;
a second portion of said low pressure EGR loop in fluidic connection with said EGR mixer and with said compressor; and
a third portion of said low pressure EGR loop in fluidic connection with said compressor and with said intake manifold air inlet.

6. The system of claim 5 wherein said EGR mixer comprises an adjustable EGR gas inlet to vary the amount of EGR gas entering said EGR mixer.

7. The system of claim 6 further comprising a valve to adjust said EGR gas inlet.

8. The system of claim 7 wherein said valve comprises a hollow piston.

9. An EGR mixer for use in a long route EGR system, said mixer comprising:
a chamber for receiving fresh air and EGR gas;
an EGR gas inlet in fluidic communication with said chamber for sending EGR gas into said chamber; and
a valve disposed between said chamber and said EGR gas inlet for varying the amount of EGR gas entering said chamber.

10. The mixer of claim 7 further comprising:
at least one outer wall and at least one inner wall, said inner and said outer walls defining a cavity therebetween, said at least one inner wall defining said chamber;
at least one aperture in said at least one inner wall;
said EGR gas inlet disposed on said at least one outer wall for receiving EGR gas into said cavity then into said chamber through said at least one aperture;
a fresh air inlet at a first end of said mixer for receiving air into said chamber for mixing with EGR gas, and an air outlet at a second end of said mixer for the exit of a mixture of fresh air and EGR gas; and
wherein said valve comprises a hollow piston disposed within said chamber, abutting said at least one aperture, and axially movable within said chamber to close, partially close, or fully open said at least one aperture.
